(19) United States
(12) Patent Application Publication
(10) Pub. No.: US 2026/0004229 A1
(43) Pub. Date: Jan. 1, 2026

(54) REAL-TIME RETAIL OUT-OF-SHELF DETECTION

(71) Applicant: NCR Voyix Corporation, Atlanta, GA (US)

(72) Inventors: Shiran Abadi, Tel-Aviv (IL); Noa Shmulevich, Tel-Aviv (IL)

(21) Appl. No.: 18/758,051

(22) Filed: Jun. 28, 2024

(51) Int. Cl. G06Q 10/087; G06Q 10/0631

(52) U.S. Cl. CPC G06Q 10/087; G06Q 10/06315

(57) ABSTRACT

A robust, data-driven model for detecting Out-of-Shelf (OOS) events in retail environments in real-time. Utilizing transactional logs, the system employs a statistical model to analyze sales data across specific intervals, identifying significant deviations from expected sales patterns. By harnessing noise within the data, the model generates a probability density function for each item, facilitating the detection of unlikely sales drops. Alerts are triggered when sales fall below a predefined significance level, enabling immediate remedial action. This innovative approach offers a cost-effective, scalable solution to minimize sales interruptions and enhance item inventory management.

### BACKGROUND

In the retail industry, Out-of-Shelf (OOS) situations, where products are unavailable on the shelf when customers seek to purchase them, represent a significant challenge. These occurrences not only result in immediate sales losses but can also lead to broader consequences such as the loss of loyal customers and overall store revenue. Traditional methods for managing OOS situations include manual inspections, the use of weight scales on shelves, and visual monitoring of shelves through cameras, all of which are labor-intensive and costly. Furthermore, existing automated systems that rely on sales forecasting are prone to inaccuracies due to the inherent noise of sales data in small time intervals, and often fail to adapt to real-time market conditions, leading to frequent false positives and negatives. Thus, there is a pressing need for an innovative solution that can detect and address sales interruptions effectively and in real-time, leveraging the vast amounts of data generated in retail environments to provide timely and accurate management of inventory availability.

### BRIEF DESCRIPTION OF THE DRAWINGS

FIG. 1 is a diagram of a system for real-time retail out-of-shelf (OOS) detection, according to an example embodiment.

FIG. 2 is a diagram of a method for real-time retail OOS detection, according to an example embodiment.

FIG. 3 is a diagram of another method for real-time retail OOS detection, according to an example embodiment.

### DETAILED DESCRIPTION

In the retail sector, the phenomenon of Out-of-Shelf (OOS) is a pervasive issue that significantly impacts customer satisfaction and store revenue. OOS situations occur when products that consumers intend to purchase are not available at the store, leading to immediate sales losses. The implications of such events extend beyond the loss of individual sales; they can result in the loss of entire shopping baskets if complementary products are also abandoned by the shopper. Moreover, repeated OOS incidents can erode customer loyalty, prompting consumers to switch to competing retailers. Traditional methods to manage OOS, such as manual shelf checks and mechanical or digital monitoring systems like weight scales and cameras, are not only resource-intensive but also fall short in accuracy and timeliness.

When the sales data for a current interval indicates that the quantity sold's probability falls below or is equal to a certain threshold of expected sales (e.g., the lower 5% of the expected sales), the system triggers an alert indicating a potential OOS event. This real-time detection allows store managers to take immediate action to rectify the issue, whether it be restocking the item or correcting an item shelf or display misplacement. The system's reliance on statistical significance rather than fixed thresholds for each item enhances its adaptability and reduces false positives and negatives, making it a versatile tool adaptable to various retail environments and product types. This innovative approach not only improves inventory management but also enhances customer satisfaction by ensuring product availability, thereby supporting sustained business growth and customer retention.

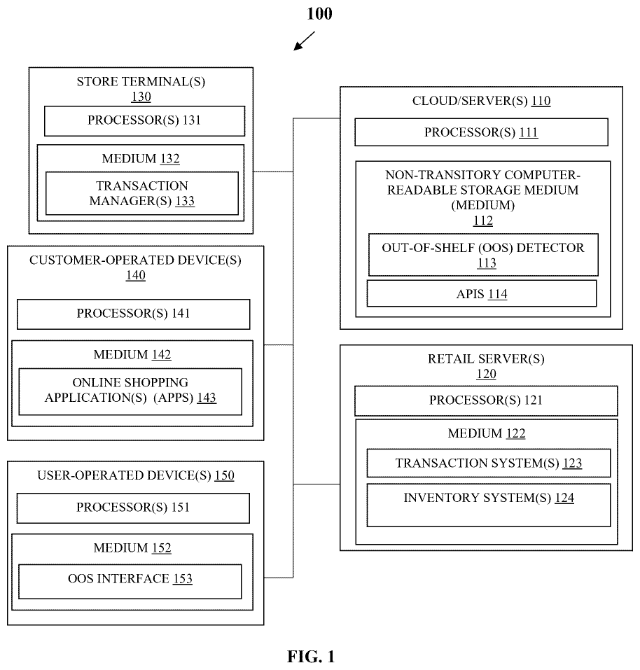

FIG. 1 is a diagram of a system 100 for real-time retail OOS detection, according to an example embodiment. Notably, the components are shown schematically in greatly simplified form, with only those components relevant to understanding of the embodiments being illustrated.

Furthermore, the various components (that are identified in the FIG. 1) are illustrated and the arrangement of the components is presented for purposes of illustration only. It is to be noted that other arrangements with more or less components are possible without departing from the teachings of real-time retail OOS detection presented herein and below.

System 100 includes a cloud 110 (also referred to as “server” or “cloud server” herein), a plurality of retail servers 120, store terminals 130, customer-operated devices 140, and user-operated devices 150. Cloud 110 includes at least one processor 111 and a non-transitory computer-readable storage medium (“medium”) 112, which includes instructions for an OOS detector 113 and application programming interfaces (“APIs”) 114. The executable instructions when executed by the processor 111 cause processor 11 to perform operations discussed herein and below with respect to 113 and 114.

Each retail server 120 includes at least one processor 121 and a medium 112, which includes instructions for a transaction system 123 and an inventory system 124. The instructions when executed by the processor 121 cause the processor 121 to perform operations discussed herein and below with respect to 123-124.

Each store terminal 130 includes at least one processor 131 and a medium 132, which includes instructions for a transaction manager 133. The instructions when executed by the processor 131 cause the processor 131 to perform operations discussed herein and below with respect to 133.

Each customer-operated device 140 includes at least one processor 141 and a medium 142, which includes instructions for an online shopping application (“app”) 143. The instructions when executed by the processor 141 cause the processor to perform operations discussed herein and below with respect to 143.

Each user-operated device 150 includes at least one processor 151 and a medium 152, which includes instructions for an OOS interface 153. The instructions when executed by the processor 151 cause the processor to perform operations discussed herein and below with respect to 153.

Initially, OOS detector 113 collects a large amount of historical transaction data from a plurality of stores associated with retailers. OOS detector 113 obtains the historical transaction data from transaction systems 123 associated with retail servers 120 of the retailers. OOS detector 113 separates the historical transaction data into separate data sets by store and by retailer. In an embodiment, OOS detector 113 also obtains product catalogs for each of the stores. The product catalogs identify item identifiers for each item offered and available at each store. In an embodiment, the OOS detector 113 obtains the transaction data from transaction logs of the retailers, each transaction log identifying the store to which the log is associated with, and the transaction log include details for a given transaction such as item identifier, quantity sold, date, time of day, day of week, etc.

The OOS detector 113 also continuously receives real-time transaction data for transactions occurring at the stores via APIs 114 from transaction managers 133 of terminals 130 and from transaction systems 123 of retailer servers 120. The OOS detector 113 uses an item total sold at a given store for a given item during a current interval of time to compare the actual total item sold amount against a probability distribution generated from the historical transaction data for the store and the item. To create a time-relevant reference the OOS detector 113 generates the probability distribution for the current interval of time by randomly sampling the historical transaction data for historical item sold totals that occurred on a same range of the day (e.g., hour) and a same day of week in previous weeks.

The OOS detector 113 creates a probability distribution function (PDF) from the randomly sampled historical transaction data and smooths the distribution of probabilities for the sold item totals using a Gaussian Kernel-Density Estimate (KDE). This produces a smooth distribution of probabilities for sold item totals over the current interval of time that estimates how likely different sold item totals are likely to occur at the given store.

The OOS detector 113 uses the smooth probability distribution constructed from randomly sampled historical transaction data for a given item of a given store and associated with a same time of day and a same day of week as the current interval of time for purposes of identifying significantly unlikely actual item sold totals associated with the current interval of time. For example, when the OOS detector 113 compares an actual and current item sold total for a sub interval of time within the current interval of time against the probability distribution and discovers an item total with a probability of 5% or less (i.e., the current item sold total is provided as input for the sub interval of time and the PDF returns the probability of 5% or less), this is an indication that something is amiss with respect to the item such as the store is out of stock of the item, the item is not stocked on its corresponding self, the item is understocked on the shelf, or the item inventory is running low at the store. In fact, experimentation has revealed that when an actual sold item total is associated with a significantly unlikely item sold probability there is a strong correlation that the item is OOS.

Conventional item OOS approaches are unreliable at fine-grain or smaller intervals of time because of noise associated with the analyzed data. Thus, conventional approaches rely on coarse grain or larger intervals of time to weed out and overcome the noise. The approaches used here actually leverages and uses that noise to arrive at a more accurate OOS prediction. This is achieved because the training data is randomly sampled over a large and diverse set of historical transaction data.

During operation of system 100, OOS detector 113 randomly continuously samples the historical transaction data every first interval of time (e.g., every hour). The randomly sampled data set is referred to herein as “training data.” The randomly sampled data is selected from the historical transaction data based on a current calendar date associated with the first interval of time, a current time of day associated with the first interval of time, and a current day of week associated with the first interval of time. That is, each record in the training data set for a given store comports with a same time of day and a same day of week as that which is associated with the first interval of time.

Next, OOS detector 113 creates a PDF using a Gaussian KDE to smooth and normalize the item sold total probabilities for the given item over every second interval (e.g., every 15 minutes) of time within first interval of time (e.g., 1 hour) creating a bell curve distribution of item sold probabilities totals every second interval over the first interval. At second intervals of time (e.g., every 15 minutes), the OOS detector 113 compares a then current actual item sold total for the store against the sold total probabilities using the PDF. The PDF returns a probability for the current actual item sold total based on the smoothed and normalized distribution of item sold total probabilities constructed from the training data. When the probability returned is less than a predefined probability (e.g., 5%), OOS detector 113 uses API 114 to send a real-time alert to a user through OOS interface 153.

In an embodiment, the OOS detector 113 sends real-time alerts and alert information (i.e., store identifier, item identifier, current actual item sold total, time of day, calendar date, etc.) to an inventory system 124 associated with the corresponding store using APIs 114. This causes inventory system 124 to initiate and process an automatic workflow to inspect inventory levels for the item and perform inventory operations to rectify any inventory shortages for the item being experienced by the store.

In an embodiment, OOS detector 113 sends real-time alerts and alert information to a transaction system 123 associated with the corresponding store using APIs 114. This causes transaction system to initiate and process an automatic workflow to notify relevant staff of the store about a potential OOS situation for the item and instruct staff to restock the shelf associated with the item.

In an embodiment, the OOS detector 113 sends real-time alerts as text messages using API 114 to user-operated devices 150 of relevant store personnel associated with restocking the item on a shelf of the store. In an embodiment, the OOS detector 113 sends the real-time alerts to any combination of the OOS interface 153, the transaction system 123, the inventory system, and user-operated device 150.

System 100 provides real-time or near real-time notifications or alerts for sales interruption events associated with OOS item situations at any given store. A statistical model is implemented which does not simply raise alerts on zero item sales and does not require a set threshold on low item inventory quantities or on fast moving items. The statistical model provides statistical significance meaning to incidents. OOS detector 113 performs continuous large scale resampling from large historical transaction data which allows the OOS detector 113 to harness noise associated with item noise during extremely small intervals of time (e.g., 15 minutes) for purposes of creating a highly accurate PDF. Furthermore, because of this approach, the system inherently and accurately accounts for new features, such as holidays, promotions, etc. which are not explicitly accounted for but are accurately accounted for based on the statistical model associated with the PDF.

Although the conventional approaches to OOS detection are plentiful in the industry, each approach is inferior to the teachings provided herein. For example, manual inspection approaches are labor intensive and require constant checks. Shelf weigh scale approaches require specific hardware and related expenses for each shelf of a store and require staff to support the hardware. Camera with vision detection approaches requires camera coverage of the store shelves and training artificial intelligence models to identify items and identify low item occupancy on the shelves. Time series approaches based on daily item sales forecasts for detecting deviations from the forecasts are not easily optimized due to the likely noise present in the sales data during small intervals of time during any given day. As a result, detecting the deviations from noisy forecasts cannot provide accurate OOS situations. Approaches that use a model to raise an alert when there are zero item sales for fast moving items results in too many false positives and false negatives. The false positives are items that are sold in large quantities at some hours during a day, and are thus fast moving, but for which zero sales might in fact be common for other hours of the day; for example, coffee or breakfast items sold at 8 PM. The false negatives are items that are sold in very high quantities but do not reach absolute zero, even if there is a decrease in sales. The model approach also require specific set thresholds to define fast moving items and may least to avoiding items that are steadily sold in medium quantities throughout any given day.

System 100 solves and alleviates all the problems associated with these conventional approaches by generating a large training data set from a large pool of historical transaction data. The training data is randomly sampled for transaction data associated with a same time of day and a same day of week as a current interval of time being evaluated. Noise in the data is leveraged and used when it appears in the random sample and accounted for when the PDF is created and smoothed into a bell curve.

In system 100, noise within the transactional data, which traditionally complicates sales analysis, is ingeniously leveraged to enhance the accuracy and reliability of the detection process. Unlike conventional systems that attempt to filter out noise, leading to potential loss of valuable data nuances, this system 100 incorporates noise as a valuable component of its analytical model. By employing a sophisticated statistical approach, the system uses the variability introduced by noise to refine the PDF. This inclusion allows for a more robust representation of sales patterns, capturing subtle fluctuations that might indicate emerging OOS events. The noise, therefore, contributes positively by providing a richer dataset from which the system can learn and make more informed predictions, significantly reducing the likelihood of false positives and negatives that are common in less dynamic models. This innovative use of noise not only improves the system's predictive precision but also enhances its adaptability to real-world retail environments where sales data is inherently noisy.

The statistical model of system 100 is a key innovation that sets it apart from traditional OOS detection methods. This model employs a Gaussian KDE to create a smooth PDF for each item's sales data across various time intervals. Crucially, the model incorporates ‘noise’—random fluctuations and anomalies in sales data—as a beneficial element rather than a detriment. By integrating these fluctuations into the PDF, the model gains a more nuanced understanding of typical versus atypical sales patterns. This nuanced approach allows the system 100 to identify statistically significant deviations that indicate true OOS events with greater precision. The inclusion of noise enhances the model's sensitivity to subtle but critical changes in sales dynamics, enabling it to predict OOS events more accurately and reduce false alerts. This sophisticated use of statistical techniques to harness noise rather than eliminate it represents a significant advancement in the field of retail analytics, providing a robust, data-driven foundation for OOS detection that adeptly applies effectively to the complex, variable nature of retail environments

System 100 exemplifies adaptability and continuous learning through its dynamic handling of transaction data. By continuously integrating real-time transaction data into its historical dataset, system 100 constantly updates and refines its probability density functions (PDFs) for each item. This ongoing learning process allows System 100 to adjust to changing sales patterns, seasonal variations, and unique store-specific trends without manual recalibration. As new sales/transaction data is assimilated, the system's algorithms automatically recalibrate the PDFs, ensuring that the detection of Out-of-Shelf (OOS) events remains accurate over time. This self-adjusting mechanism ensures that the system 100 remains effective even as the retail environment evolves, making it a robust solution for dynamic retail operations.

System 100 significantly reduces the occurrence of false positives and negatives, common pitfalls in traditional OOS detection systems. By leveraging a statistical model that incorporates a comprehensive range of sales data and by using noise to enhance the accuracy of the model, System 100 can discern genuine OOS events from normal sales fluctuations more effectively. The system's use of Gaussian KDE to smooth the probability distributions ensures that the thresholds for triggering alerts are based on statistically significant deviations rather than arbitrary cutoffs. This approach minimizes false alarms (false positives) that could lead to unnecessary item stock checks and reduces missed detections (false negatives), ensuring that real OOS situations are promptly and reliably identified and addressed.

Compared to existing technologies, system 100 offers a superior approach to managing OOS events, particularly in scenarios involving high sales variability. For example, consider a traditional system that uses fixed thresholds to trigger OOS alerts during a promotional event. Such systems often fail to account for the sudden increase in sales volume, leading to frequent false positives as items sell out quickly but are not necessarily OOS. In contrast, System 100 dynamically adjusts its detection parameters based on real-time and historical sales data, effectively distinguishing between expected sales surges and genuine stock shortages. This capability allows it to outperform traditional approaches, especially during high-stakes sales periods like Black Friday, where accurate OOS detection is crucial for maintaining customer satisfaction and maximizing revenue. By reducing erroneous alerts and ensuring timely restocking, system 100 enhances operational efficiency and customer experience far beyond what static, conventional systems can achieve.

When an item's current and actual item sales total for a store is determined from the PDF to be associated with an item total probability that is significantly low (e.g., 5%), a strong correlation exists that the item is OOS at the store. Thus, noise does not affect OOS determinations; there is not any manual intensive labor requirement, there is not any expensive and specialized hardware requirement; no AI models require training and maintenance; there is no requirement of identifying specific types of items and assigning thresholds to each of the types.

Furthermore, system 100 is easily scaled as an external service provided from cloud 110 and can handle large numbers of retailers and stores requiring only access to historical transaction data and real-time transaction data, which can be provided via APIs 114. Thus, system 100 is also easily integrated into existing transaction workflows through API calls. Still further, the volume of each real-time transaction data is condensed into a small record of information which is already produced by the stores and retailers in their transaction logs.

Furthermore, because real-time transaction data is retained and added to the historical transaction data, system 100 is adaptive and learns without requiring any retaining or manual intervention. This is because as the data changes, so does the training data selected through the random sampling which results in updated probability distributions associated with new emerging item sale patterns for each store. In this way, system 100 is truly data-driven and self-adjusts itself over time base on the changing underlying historical transaction data.

In an embodiment, the OOS detector 113 randomly samples the historical transaction data over a configured amount of most-recent past transactions from a current calendar date in which the OOS detector 113 is performing checks on for item sales interruptions. For example, if a current date is Jun. 1, 2024, OOS detector 113 uses the transaction data associated with the most recent and past 3 months of transaction data associated with Mar. 1, 2024, to May 31, 2024 to perform the random sampling on. The amount of most-recent past transaction selected from the historical transaction data is configurable and can be passed as an operating parameter to the OOS detector 113.

In an embodiment, the first interval of time associated with a current interval of time is a business hour over a business day (e.g., 5 hours, 12 hours, 24 hours, etc.). In an embodiment, the second interval of time associated with the probability distribution is every 15 minutes within the business hour over the business day. In an embodiment, the checked or third interval of time is every 5 minutes the OOS detector 113 checks the actual item sales for a given item against the PDF for a given item total probability. Notably, the intervals of time discussed herein and above are configurable and uses as operating parameters to OOS detector 113.

In an embodiment, the store terminal 130 is a self-service terminal or a point-of-sale terminal. In an embodiment, the customer-operated device 140 and the user-operated device 150 include any of phones, tablets, desktop computers, laptop computers, and/or wearable processing devices.

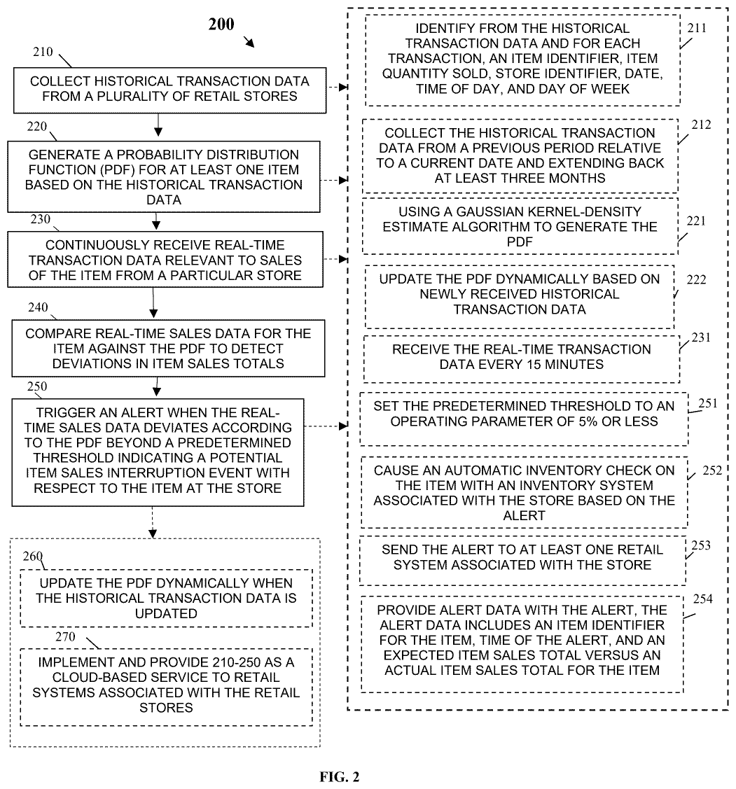

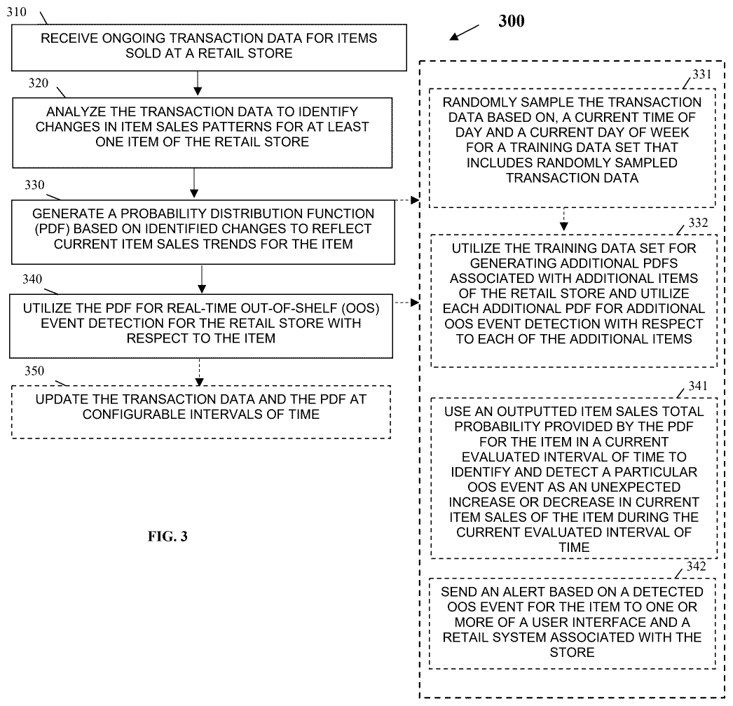

These and other embodiments are now discussed with reference to the FIGS. 2-3. FIG. 2 is a diagram of a method 200 for real-time retail OOS detection, according to an example embodiment. The software module(s) that implements the method 200 is referred to as an “item sales interruption event detector.” The item sales interruption event detector is implemented as executable instructions programmed and residing within memory and/or a non-transitory computer-readable (processor-readable) storage medium and executed by one or more processors of a device. The processor(s) of the device that executes the item sales interruption event detector are specifically configured and programmed to process the item sales interruption event detector. The item sales interruption event detector has access to one or more network connections during its processing. The network connections can be wired, wireless, or a combination of wired and wireless.

In an embodiment, the device that executes the item sales interruption event detector is a cloud 110 or cloud server 110. In an embodiment, the cloud 110 is a processing environment includes multiple servers cooperating with one another as a single logical server. In an embodiment, the item sales interruption event detector is all of or some combination of 113 and/or 114. In an embodiment, the item sales interruption event detector is provided as a SaaS to a plurality of retailers, each retailer having a subscription to cloud 110.

At 210, the item sales interruption event detector collects historical transaction data from a plurality of stores. The item sales interruption event detector receives the historical transaction data using APIs 114 to interact with transaction systems 123 of the retailers and/or interact with transaction managers 133 of terminals 130 located in the stores. The transaction systems 123 process online orders via online shopping apps 143 of customer-operated devices 150.

In an embodiment, at 211, the item sales interruption event detector identifies for each transaction of the historical transaction data an item identifier, an item quantity sold, a store identifier, a date, a time of day, and day of week. In an embodiment, at 212, the item sales interruption event detector collects the transaction data from a previous period relative to a current date and extending back at least three months.

At 220, the item sales interruption event detector generates a PDF for at least one item of a particular store based on corresponding historical transaction data. In an embodiment, at 221, the item sales interruption event detector uses a Gaussian KDE algorithm to generate the PDF. In an embodiment, at 222, the item sales interruption event detector dynamically updates the PDF based on newly received historical transaction data.

At 230, the item sales interruption event detector continuously receives real-time transaction data relevant to sales of the item from a particular retail store. In an embodiment, the item sales interruption event detector receives the real-time transaction data every 15 minutes. In an embodiment, the interval with which the real-time transaction data is received is 15 minutes or the interval for receipt of the real-time transaction data is configurable as an operating parameter to the item sales interruption event detector.

At 240, the item sales interruption event detector compares the real-time sales data for the item against the PDF to detect deviations in item sales totals. That is, the PDF returns a probability associated with an actual item sales total provided by the item sales interruption event detector based on the real-time transaction data. The item sales interruption event detector compares that probability.

At 250, the item sales interruption event detector triggers a real-time alert when the real-time sales data deviates according to the outputted probability received from the PDF beyond a predetermined threshold. The deviation indicating that a potential sales interruption vent with respect to the item at the store.

In an embodiment, at 251, the item sales interruption event detector sets the predetermined threshold to an operating parameter value of 5% or less. Again, the operating parameter is a configurable operating parameter provided to item sales interruption event detector as a parameter or set in a file read by the item sales interruption event detector upon initiation on cloud server 110.

In an embodiment, at 252, the item sales interruption event detector causes an automatic inventory check on the item with an inventory system 124 associated with the particular store based on the alert. The item sales interruption event detector provides or sends the alert to the inventory system 124 via an API 114.

In an embodiment, at 253, the item sales interruption event detector sends the alert to at least one retail system associated with the particular retail store. In an embodiment, the retail system is transaction system 123. In an embodiment, the at least one retail system is both transaction system 123 and inventory system 124.

In an embodiment, at 254, the item sales interruption event detector provides alert data with the alert. In an embodiment, the alert data includes an item identifier for the item, a time of the alert, and an expected item sales total versus an actual item sales total for the item.

In an embodiment, at 260, the item sales interruption event detector updates the PDF when the historical transaction data is updated. That is at predefined intervals of time, the item sales interruption event detector updates the historical transaction data to include most recent and past data from the current date and when the historical transaction data is updated, the item sales interruption event detector updates the PDF.

In an embodiment, the item sales interruption event detector (210-250) is implemented as a cloud-base service to retail systems associated with retail stores. In an embodiment, the retail systems at least include transaction system 123, inventory system 124, and any analytics interface such as OOS interface 153.

The item sales interruption event detector continuously iterates to 210 are first intervals of time for purposes of updating the historical transaction data, updating the PDF, receiving current real-time transaction data, and determining whether an alert is necessitated. This ensures that each business day and each hour of within the business day the item sales interruption event detector is using an updated PDF to obtain a probability for the actual item sales total of any given item of the store.

In situations that may make previously generated PDFs irrelevant, since items consumed changed over time and change based on the season, the item sales interruption event detector generates new PDFs over recent historical transaction data to replace the previous PDFs. For example, an umbrella might be purchased in relatively low quantities in the beginning of the fall, which is irrelevant to umbrella sales for a store in February based on historical climate conditions known for the geographic location of the store. February is winter for which it is known that more rain falls at the store's location. The item sales interruption event detector accounts for this by creating new PDFs using recent historical transaction data for the store—the transaction data exhibits increased umbrella sales as the winter months approach and as fall comes to end at the store's location. The item sales interruption event detector is data driven, such that the as underlying historical sales data changes so too does the PDFs to account for these changes. The item sales interruption event detector is capable of detecting changing item sales patterns without hardcoded conditions of manual interventions. Thus, the item sales interruption event detector is dynamically adaptive and is able to detect and respond to external conditions affecting item sales.

FIG. 3 is a diagram of another method 300 for real-time retail OOS detection, according to an example embodiment. The software module(s) that implements the method 300 is referred to as an “OOS item detector” The OOS item detector is implemented as executable instructions programmed and residing within memory and/or a non-transitory computer-readable (processor-readable) storage medium and executed by one or more processors of a device. The processors that execute the OOS item detector are specifically configured and programmed to process the pricing analytics manager. The OOS item detector has access to one or more network connections during its processing. The network connections can be wired, wireless, or a combination of wired and wireless.

In an embodiment, the device that executes the OOS item detector is a cloud 110 or a cloud server 110. In an embodiment, the cloud is a processing environment that comprises multiple servers cooperating with one another as a single logical server.

In an embodiment, the OOS item detector is all or some combination of 113, 114, and/or the method 200. The OOS item detector presents another and, in some ways, enhanced processing perspective to that which was described above with the method 200 of FIG. 2.

At 310, the OOS item detector receives ongoing transaction data for items sold at a retail store. That is, the OOS item detector is continuously collecting and/or receiving updated historical transaction data and real-time transaction data for the store. In an embodiment, the transaction data is included in transaction logs for in-store transactions and online transactions of the retail store.

At 320, the OOS item detector analyzes the transaction data to identify changes in item sales patterns for at least one item of the retail store. At 330, the OOS item detector generates a PDF based on identified changes to reflect current item sales trends for the item.

In an embodiment, at 331, the OOS item detector randomly samples the transaction data based on a current date, a current time of day, and a current day of week to create a training data set that includes the randomly sampled transaction data occurring in the historical transaction data on a same time of day and/or a same current day of week as the current date's time of day and day of week. In an embodiment of 331 and at 332, the OOS item detector utilizes the training data set for generating additional PDFs associated with additional items of the retail store. The OOS item detector utilizes each additional PDF for additional OOS event detection with respect to each of the additional items.

At 340, the OOS item detector utilizes the PDF for real-time OOS event detection for the retail store with respect to the item. The OOS event detection informs the store that there is a high likelihood that the item is not full stocked or is missing from its corresponding shelf in the store and needs to be replenished on the shelf.

In an embodiment, at 341, the OOS item detector uses an outputted item sales total probability provided by the PDF for the item in a current evaluated interval of time to identify and detect a particular OOS event. The particular OOS event representing an unexpected increase or decrease in current item sales for the item during the current evaluated interval of time.

In an embodiment, at 342, the OOS item detector send a real-time alert based on a detected OOS event for the item to one or more of a user interface (e.g., OOS interface 153) and at least one retail system (e.g., transaction system 123 and inventory system 124) associated with the retail store. The real-time alert causes a remedial action by the store personnel or the store systems to address the shelf stock of the item at the store or address inventory issues associated with the item.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
collecting historical transaction data from a plurality of retail stores;
generating a probability distribution function (PDF) for at least one item based on the historical transaction data;
continuously receiving real-time transaction data relevant to sales of the at least one item from a particular retail store;
comparing real-time sales data for the at least one item against the PDF to detect deviations in item sales totals; and
triggering an alert when the real-time sales data deviates according to the PDF beyond a predetermined threshold indicating a potential item sales interruption event with respect to the at least one item at the particular retail store.

2. The method of claim 1, further comprising updating the PDF dynamically when the historical transaction data is updated.

3. The method of claim 1, further comprising implementing and providing the method as a cloud-based service to retail systems associated with the retail stores.

4. The method of claim 1, wherein collecting further includes identifying from the historical transaction data and for each transaction in the historical transaction data, an item identifier, item quantity sold, store identifier, date, time of day, and day of week.

5. The method of claim 1, wherein collecting further includes collecting the historical transaction data from a previous period relative to a current date and extending back at least three months.

6. The method of claim 1, wherein generating further includes using a Gaussian Kernel-Density Estimate algorithm to generate the PDF.

7. The method of claim 1, wherein generating further includes updating the PDF dynamically based on newly received historical transaction data.

8. The method of claim 1, wherein continuously receiving further includes receiving the real-time transaction data every 15 minutes.

9. The method of claim 1, wherein triggering further includes setting the predetermined threshold to an operating parameter, wherein the operating parameter is 5% or less.

10. The method of claim 1, wherein triggering further includes causing an automatic inventory check on the at least one item with an inventory system associated with the particular store based on the alert.

11. The method of claim 1, wherein triggering further includes sending the alert to at least one retail system associated with the particular store.

12. The method of claim 1, wherein triggering further includes providing alert data with the alert, wherein the alert data includes an item identifier for the at least one item, time of the alert, and an expected item sales total versus an actual item sales total.

13. A method, comprising:
receiving ongoing transaction data for items sold at a retail store;
analyzing the transaction data to identify changes in item sales patterns for at least one item of the retail store;
generating a probability distribution function (PDF) based on identified changes to reflect current item sales trends for the at least one item; and
utilizing the PDF for real time out-of-shelf (OOS) event detection for the retail store with respect to the at least one item.

14. The method of claim 13, wherein generating further includes randomly sampling the transaction data based on a current time of day and a current day of week to generate the PDF for a training data set that comprises randomly sampled transaction data.

15. The method of claim 14, wherein randomly sampling further includes utilizing the training data set for generating additional PDFs associated with additional items of the retail store and utilizing each additional PDF for additional OOS event detections with respect to each of the additional items.

16. The method of claim 13, wherein utilizing further includes using an outputted item sales total probability provided by the PDF for the at least one item in a current evaluated interval of time to identify and detect a particular OOS event as an unexpected increase or decrease in current item sales of the at least one item during the current evaluated interval of time.

17. The method of claim 13, wherein utilizing further includes sending an alert based on a detected OOS event for the at least one item to one or more of a user interface and a retail system associated with the retail store.

18. The method of claim 13, further comprising updating the transaction data and the PDF at configurable intervals of time.

19. A system, comprising:
at least one processor configured to execute instructions from a non-transitory computer-readable storage medium; and
the instructions when executed by the at least one processor from the non-transitory computer-readable storage medium cause the at least processor to perform operations comprising:
continuously collecting historical transaction data and real-time transaction data from transaction logs associated with a retail store using an API to interact with a transaction system and terminals of the retail store;
randomly sampling the historical transaction data based on a current time of day and a current day of week for a current interval of time to create a training data set from the randomly sampled data;
generating at least one probability distribution function (PDF) for item sales totals for at least one item associated with the retail store based on the training data set;
providing at least one current item sales total obtained from the real-time transaction data for a sub interval of time within the current interval of time as input to the at least one PDF;
receiving at least one item sales total probability for the at least one item as output from the at least one PDF;
comparing the at least one item sales total probability against a predefined threshold; and
sending at least one alert to at least a user interface associated with the retail store when the at least one item sales total probability falls below or is equal to the threshold as an indication that the at least one item is associated with at least one out-of-shelf (OOS) event that needs addressed by the retailer.

20. The system of claim 19, wherein the instructions further cause the at least one processor to perform additional operations comprising:
iterating to the continuously collecting at a third interval of time for updating the historical transaction data, updating the training data set, and updating the at least one PDF.
